(19) United States
(12) Patent Application Publication
(10) Pub. No.: US 2026/0105752 A1
(43) Pub. Date: Apr. 16, 2026

(54) TRAFFIC ANALYZING METHOD AND DEVICE THEREOF

(71) Applicant: LEOTEK CORPORATION, Taipei City (TW)

(72) Inventor: Heng-An TZOU, Taipei City (TW)

(21) Appl. No.: 19/270,875

(22) Filed: Jul. 16, 2025

Related U.S. Application Data
(60) Provisional application No. 63/707,271, filed on Oct. 15, 2024.

(51) Int. Cl. G06V 20/54; G06V 10/56; G06V 10/62; G06V 10/764; G06V 10/82; G06V 10/94; G06V 20/40

(52) U.S. Cl. CPC G06V 20/54; G06V 10/764; G06V 10/82; G06V 10/95; G06V 20/41; G06V 20/44; G06V 20/49; G06V 10/56; G06V 10/62

(57) ABSTRACT

A traffic analyzing device is provided. The traffic analyzing device may include a camera, a processor and a memory. The camera be configured to capture a video associated with a scene of a road. The memory may be coupled to the processor. The processor may be configured to apply a first machine learning model to analyze a first segment of the video to generate a first traffic depiction, embed the first traffic depiction in a first video encoding parameter synchronized with the first segment of the video, and apply a second machine learning model to analyze a second segment of the video according to the first video encoding parameter to generate a second traffic depiction.

### CROSS REFERENCE TO RELATED APPLICATIONS

This application claims the benefit of U.S. Provisional Application No. 63/707,271 filed on Oct. 15, 2024, the entirety of which is incorporated by reference herein.

### BACKGROUND OF THE INVENTION

### Field of the Invention

The invention generally relates to a wireless communications technology, and more particularly, it relates to traffic analysis based on a machine learning model or an artificial intelligence (AI) model.

### Description of the Related Art

Unless otherwise indicated herein, the approaches described in this section are not prior art to the claims listed below and are not admitted as prior art by inclusion in this section.

In conventional technologies, artificial intelligence (AI) is widely applied in different applications. For example, a machine learning model or an AI analysis model may be applied to traffic analysis. However, because of the limits on the computing capability of edge devices, most operations performed through a machine learning model or an AI analysis model for traffic analysis are usually performed by a backend apparatus (e.g., a remote server or a cloud server). That is, edge devices may need to transmit videos to the backend apparatus first, and then the backend apparatus may perform the traffic analysis according to the videos using the machine learning model or the AI analysis model. Therefore, the latency for the traffic analysis may be generated.

Therefore, how to perform traffic analysis immediately and fast in an edge device is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to traffic analysis with respect to the apparatus. It is believed that the issue described above can be avoided or otherwise alleviated by implementing one or more of the proposed schemes described herein.

An embodiment of the invention provides a traffic analyzing device. The traffic analyzing device may comprise a camera, a processor and a memory. The camera be configured to capture a video associated with a scene of a road. The memory may be coupled to the processor. The processor may be configured to apply a first machine learning model to analyze a first segment of the video to generate a first traffic depiction, embed the first traffic depiction in a first video encoding parameter synchronized with the first segment of the video, and apply a second machine learning model to analyze a second segment of the video according to the first video encoding parameter to generate a second traffic depiction.

In some embodiments, the first machine learning model may comprise a convolutional neural network (CNN) model and the second machine learning model comprises a transformer model.

In some embodiments, the processor may be further configured to generate the first traffic depiction during a first period of time, and generate the second traffic depiction from the first segment to the second segment of the video during a second period of time. The second period of time may be longer than the first period of time.

In some embodiments, the processor may be further configured to obtain the first location of an object in the first segment of the video through the first machine learning model, encode the first location into the first traffic depiction, obtain the trajectory of the object from the first segment to the second segment through the second machine learning model, and encode the trajectory into the second traffic depiction.

In some embodiments, the processor may be further configured to determine a first classification of the object in the first segment through the first machine learning model, encode the first classification into the first traffic depiction, and generate a description of the object from the first segment to the second segment according to the first classification and the trajectory through the second machine learning model.

In some embodiments, the processor may be further configured to determine a computational resource of the traffic analyzing device, determine, whether to generate the first classification and the first location of the object based on the computational resource, and prioritize generating the first location in an event that the computational resource is not enough.

In some embodiments, the second segment may follow the first segment of the video, and the processor may be further configured to embed the second traffic depiction in a second video encoding parameter synchronized with the second segment.

In some embodiments, the processor may be further configured to obtain a second location and a second classification of an object in the second segment through the first machine learning model, and analyze the second segment, the first video encoding parameter, the second location, and the second classification through the second machine learning model to generate a description associated with the object.

In some embodiments, the video may comprise a traffic light, and the processor may be further configured to determine the traffic light phase of the traffic light through the first machine learning model.

In some embodiments, the processor may be further configured to obtain the traffic light phase of a traffic light from a traffic controller which is connected to the traffic light.

In some embodiments, the processor may be further configured to switch the first machine learning model to another machine learning model in an event that a server indicates that the accuracy of the first machine learning model is lower than the accuracy of the another machine learning model.

In some embodiments, the processor may be further configured to determine whether to update the first machine learning model and second machine learning model according to an indication from a server. The server may calculate a computational resource of the traffic analyzing device to generate the indication.

In some embodiments, the first segment and second segment may respectively comprise a first group of pictures (GOP) and a second GOP. The first video encoding parameter and a second video encoding parameter may respectively include a first supplemental enhancement information (SEI) following the first GOP and a second SEI following the second GOP.

In some embodiments, in response to a green light phase of a traffic light, the processor may be further configured to apply a traffic counting model to count the number of vehicles on the road in a segment of the video preceding the first segment of the video. In some embodiments, in response to a yellow light phase of the traffic light, the processor may be further configured to apply a fast wheel trajectory model to generate trajectories of vehicles in a segment of the video. In some embodiments, in response to a red light phase of the traffic light, the processor may be further configured to apply a fleet length calculation model to generate the total length of vehicles traveling on the road in a segment of the video.

In some embodiments, the processor may be further configured to generate a distributed traffic depiction according to a plurality of videos from different cameras through the first machine learning model, embed the distributed traffic depiction in a video encoding parameter of each video, and determine whether to switch to another machine learning model according to the distributed traffic depiction.

An embodiment of the invention provides a traffic analyzing method. The traffic analyzing method may be applied to a traffic analyzing device. The traffic analyzing method may comprise the following steps. The traffic analyzing device may capture a video associated with a scene of a road. Then, the traffic analyzing device may apply a first machine learning model to analyze a first segment of the video to generate a first traffic depiction. Then, the traffic analyzing device may embed the first traffic depiction in a first video encoding parameter synchronized with the first segment of the video. Then, the traffic analyzing device may apply a second machine learning model to analyze a second segment of the video according to the first video encoding parameter to generate a second traffic depiction.

Other aspects and features of the invention will become apparent to those with ordinary skill in the art upon review of the following descriptions of specific embodiments of the traffic analyzing method and device.

### BRIEF DESCRIPTION OF THE DRAWINGS

The invention will become more fully understood by referring to the following detailed description with reference to the accompanying drawings, wherein:

FIG. 1 is a block diagram of a traffic analyzing system according to an embodiment of the application.

FIG. 2 is a block diagram illustrating a traffic analyzing device according to an embodiment of the application.

FIG. 3 is a schematic diagram illustrating segment format of the video according to an embodiment of the invention.

FIG. 4 is a flow chart illustrating a traffic analyzing process according to an embodiment of the invention.

FIGS. 5a and 5b collectively form a flow chart illustrating a machine learning model switch method based on the light phase of the traffic light according to an embodiment of the invention.

FIG. 6 is a schematic diagram illustrating a traffic analyzing for an intersection according to an embodiment of the invention.

FIG. 7 is a flow chart illustrating a traffic analyzing method 700 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

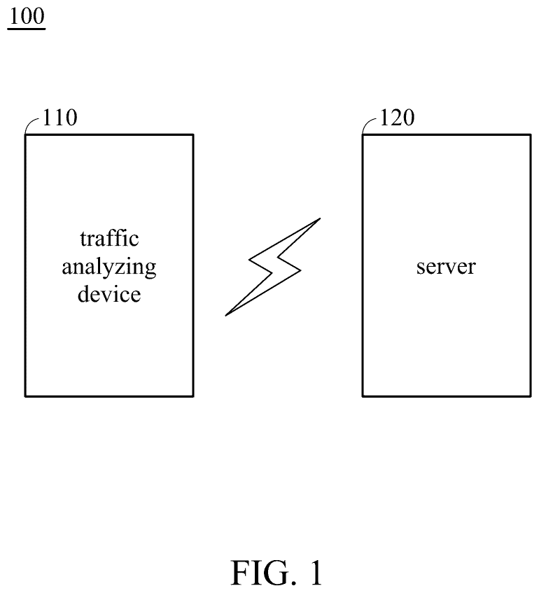

FIG. 1 is a block diagram of a traffic analyzing system 100 according to an embodiment of the application. As shown in FIG. 1, the traffic analyzing system 100 may include a traffic analyzing device 110 and a server (or a backend apparatus) 120. It should be noted that, in order to clarify the concept of the invention, FIG. 1 presents a simplified block diagram in which only the elements relevant to the invention are shown. However, the invention should not be limited to what is shown in FIG. 1.

In the embodiments of the invention, the traffic analyzing device 110 may be an edge device in a network structure. The traffic analyzing device 110 may communicate with the server 120 through a wireless communication technology. The traffic analyzing device 110 may provide the traffic analyzing result to the server 120 through the wireless communication technology. The traffic analyzing device 110 may be installed at the intersection.

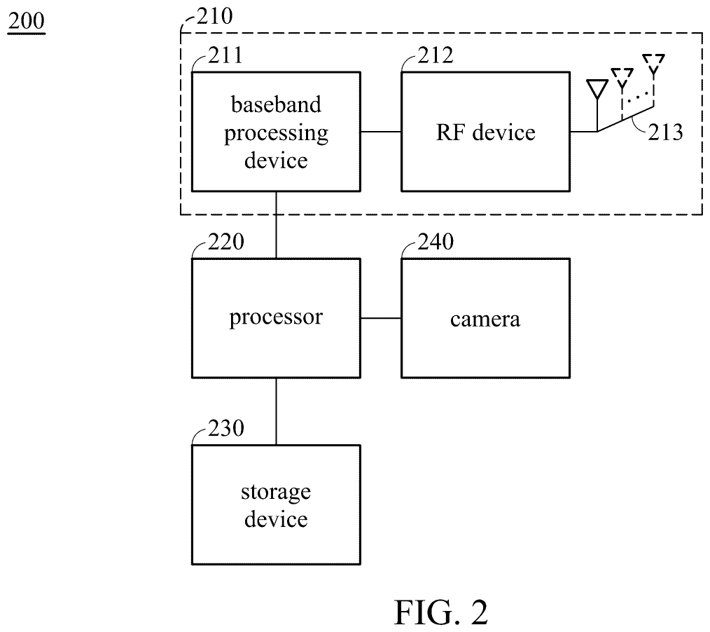

FIG. 2 is a block diagram illustrating a traffic analyzing device 200 according to an embodiment of the application. The traffic analyzing device 200 can be applied to the traffic analyzing device 110. As shown in FIG. 2, the traffic analyzing device 200 may comprise a wireless transceiver 210, a processor 220, a storage device 230, and at least one camera 240.

The wireless transceiver 210 may be configured to perform wireless transmission and reception to and from the traffic analyzing device 200.

Specifically, the wireless transceiver 210 may include a baseband processing device 211, a Radio Frequency (RF) device 212, and antenna 213, wherein the antenna 213 may include an antenna array.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the traffic analyzing device 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the server 120, storing and retrieving data (e.g., program code) to and from the storage device 230, and controlling one or more cameras to capture or extract the video (or videos) associated with a scene of a road.

In particular, the processor 220 coordinates the aforementioned operations of the wireless transceiver 210, the storage device 230, and the camera 240 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The camera (or cameras) 140 may be configured to capture or extract the video (or videos) associated with a scene of a road for traffic analysis.

It should be understood that the components described in the embodiment of FIG. 2 are for illustrative purposes only and are not intended to limit the scope of the application. For example, a traffic analyzing device may include more components, such as another camera. Alternatively, the traffic analyzing device may also include fewer components.

According to an embodiment of the invention, the traffic analyzing device 110 may capture a video (or a video footage) associated with a scene of a road. Then, the traffic analyzing device 110 may apply a first machine learning model to analyze a first segment of the video to generate a first traffic depiction. Then, the traffic analyzing device 110 may embed the first traffic depiction in a first video encoding parameter synchronized with the first segment of the video. In addition, the traffic analyzing device 110 may apply a second machine learning model to analyze a second segment of the video according to the first video encoding parameter to generate a second traffic depiction. In addition, in the embodiment, the second segment may follow the first segment of the video. The traffic analyzing device 110 may further embed the second traffic depiction in a second video encoding parameter synchronized with the second segment. In an embodiment of the invention, each traffic depiction may have a JavaScript Object Notation (JSON) file format.

According to an embodiment of the invention, the traffic analyzing device 110 may perform an image compression technology (e.g., H.264) to the video, i.e., the video may be an H.264 video or H.264 stream, but the invention should not be limited thereto). In addition, according to an embodiment of the invention, the video encoding parameter (e.g., the first video encoding parameter) encoded to the video (e.g., H.264 video) may comprise the Supplemental Enhancement Information (SEI). The SEI may comprise the traffic depiction and the SEI may be embedded in the H.264 video. According to the embodiments of the invention, the traffic analyzing device 110 may analyze the video encoding parameter (e.g., SEI) to obtain the identification results of the machine learning model or the artificial intelligence (AI) model (i.e., the traffic depiction embedded in the video encoding parameter) for the segment of the video to determine whether to switch the machine learning model for the next segment of the video.

According to an embodiment of the invention, each segment of the video may comprise a group of pictures (GOP) and a video encoding parameter (e.g., an SEI) following the GOP. For example, the first segment and second segment may respectively comprise the first GOP and the second GOP, and the first video encoding parameter and the second video encoding parameter may respectively comprise a first SEI following the first GOP and a second SEI following the second GOP.

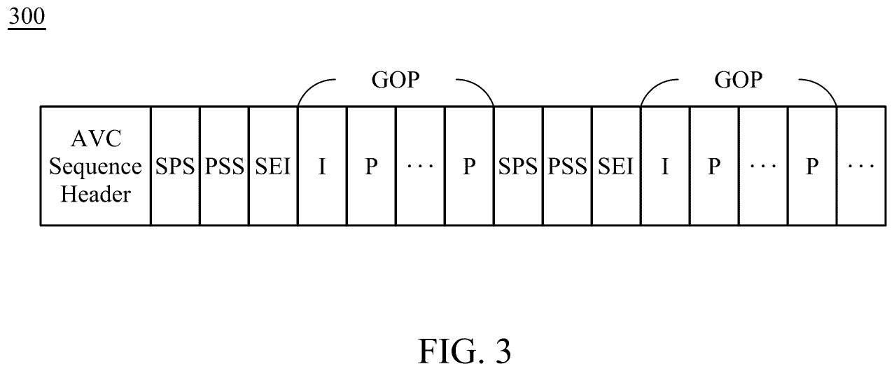

FIG. 3 is a schematic diagram illustrating segment format 300 of the video according to an embodiment of the invention. As shown in FIG. 3, each segment of the video may comprise a GOP and an SEI following the GOP. Each GOP may comprise an I-frame and a plurality of P-frames (e.g., 1 I-frame and 49 P-frames). Each segment may further comprise a sequence parameter set (SPS) and a picture parameter set (PPS). Each SEI may comprise different information for the segment. In addition, each SEI may be associated with different machine learning model. In addition, the segment format 300 may further comprise an advanced video coding (AVC) sequence header for decoding the video.

According to an embodiment of the invention, the first machine learning model may comprise a convolutional neural network (CNN) model (e.g., YOLOv8, Normalized Object Coordinate Space (NOCS), ResNet, or DenseNet, but the invention should not be limited thereto) and the second machine learning model may comprise a transformer model (e.g., LLaMa, LLaVA, or other video understanding model, but the invention should not be limited thereto), but the invention should not be limited thereto. For example, in another embodiment, the first machine learning may comprise a transformer model and the second machine learning model may comprise the CNN model. In another embodiment, each of the first machine learning model and second machine learning may comprise more than one models. That is, the traffic analyzing device 110 may apply more than one models to analyze a segment of the video.

In addition, according to an embodiment of the invention, based on the light phase of the traffic light, each of the first machine learning model and the second machine learning model may comprise a traffic counting model, a fast wheel trajectory model, and a fleet length calculation model, but the invention should not be limited thereto.

The traffic counting model may comprise a CNN model plus a transformer model, a YOLOv5 or YOLOv8 object detection model fine-tuned for vehicle counting, a RetinaNet model with focal loss for dense traffic scenes, a vision transformer (ViT) model trained on aerial traffic datasets, or a graph neural network (GNN) model that models vehicle interactions for improved count accuracy, but the invention should not be limited thereto.

The fast wheel trajectory model may comprise a CNN model, a 3D CNN model for motion pattern recognition, an optical flow-based model using FlowNet2, a recurrent neural network (RNN) or LSTM model for temporal trajectory prediction, or a transformer-based motion prediction model trained on wheel movement sequences, but the invention should not be limited thereto.

The fleet length calculation model may comprise a CNN model plus a transformer model, a 3D CNN model for spatiotemporal feature extraction, a hybrid model combining CNN with LSTM for sequential vehicle detection, a ViT model fine-tuned for vehicle segmentation, a multi-task learning model that jointly estimates vehicle count and length using shared convolutional backbones and attention mechanisms, or a depth estimation model using stereo vision or monocular depth prediction to infer vehicle spacing and fleet length, but the invention should not be limited thereto.

For example, the traffic counting model may be associated with the green light phase to calculate the traffic flow of the road, the fast wheel trajectory model may be associated with the yellow light phase to identify the trajectories of the objects in the segment of the video, and the fleet length calculation model may be associated with the red light phase to calculate the fleet length (i.e., the length of the vehicles stopping on the road for the red light) in the segment of the video. That is, the traffic analyzing device 110 may determine the type of the machine learning model (e.g., the first machine learning model or the second machine learning model) based on the light phase of the traffic light in the segment of the video.

According to an embodiment of the invention, the segment of the video may comprise a traffic light. Therefore, the traffic analyzing device 110 may determine the traffic light phase of the traffic light in the segment of the video through a machine learning model (e.g., a CNN model).

According to another embodiment of the invention, the traffic analyzing device 110 may obtain the traffic light phase of a traffic light from a traffic controller which is connected to the traffic light.

According to an embodiment of the invention, the traffic analyzing device 110 may generate the first traffic depiction during a first period of time (e.g., 1 millisecond (ms), but the invention should not be limited thereto) based on the first segment of the video through the first machine learning model. In addition, the traffic analyzing device 110 may generate the second traffic depiction from the first segment to the second segment of the video during a second period of time (e.g., 30 ms, but the invention should not be limited thereto) based on the second segment of the video and the first video encoding parameter through the second machine learning model. In an embodiment, the second period of time may be longer than the first period of time, but the invention should not be limited thereto. The length of the first period of time and the length of the second period of time may be determined based on the adopted machine learning model.

According to an embodiment of the invention, each traffic depiction (e.g., the first traffic depiction, and the second traffic depiction) may comprise at least one of the identifier of the type the scene associated with a segment of the video, location information (e.g., coordinate information in an bounding box) of the object (or objects) in the segment of the video, trajectory information of the object (or objects) (e.g., the trajectory of a car) in the segment of the video, classification (or type) information of the object (or objects) (e.g., a type of a vehicle) in the segment of the video, a description of the scene associated with the segment of the video, and a time information (e.g., a timestamp) associated with the segment of the video, but the invention should not be limited thereto.

For example, in some embodiments, the traffic analyzing device 110 may obtain a location of an object (e.g., a car) in the first segment of the video through the first machine learning model, and then encode the first location of the object into the first traffic depiction. In addition, the traffic analyzing device 110 may obtain the trajectory of the object from the first segment to the second segment through the second machine learning model, and then encode the trajectory of the object into the second traffic depiction.

In addition, in some embodiments, the traffic analyzing device 110 may further determine a first classification of the object in the first segment through the first machine learning model, and then encode the first classification into the first traffic depiction. In addition, the traffic analyzing device 110 may generate a description of the object from the first segment to the second segment according to the first classification and the trajectory through the second machine learning model.

In another example, in some embodiments, the traffic analyzing device 110 may obtain a second location and a second classification of an object in the second segment through a machine learning model (e.g., the first machine learning model). In addition, the traffic analyzing device 110 may analyze the second segment, the first video encoding parameter, the second location, and the second classification through another machine learning model (e.g., the second machine learning model) to generate a description associated with the object.

According to an embodiment of the invention, the traffic analyzing device 110 may determine its computational resource (or computational capability or computational power), e.g., the computational resource of the processor the traffic analyzing device 110. Then, the traffic analyzing device 110 may determine whether to generate or compute the classification and the location of each object in the segment of the video based on the computational resource of the traffic analyzing device 110. In an embodiment, in an event that the computational resource is not enough, the traffic analyzing device 110 may prioritize generating the location of each object without generating the classification of each object, but the invention should not be limited thereto. Specifically, if the computational resource of the traffic analyzing device 110 is not enough, the traffic analyzing device 110 may determine which operation need to prioritize being performed according to the current scenario in the segment of the video. For example, when the traffic analyzing device 110 determine the traffic light is the green light phase according to the segment of video and current computational resource of the traffic analyzing device 110 is not enough, the traffic analyzing device 110 may prioritize generating the location of each object in the segment of the video to calculate the traffic flow of the road.

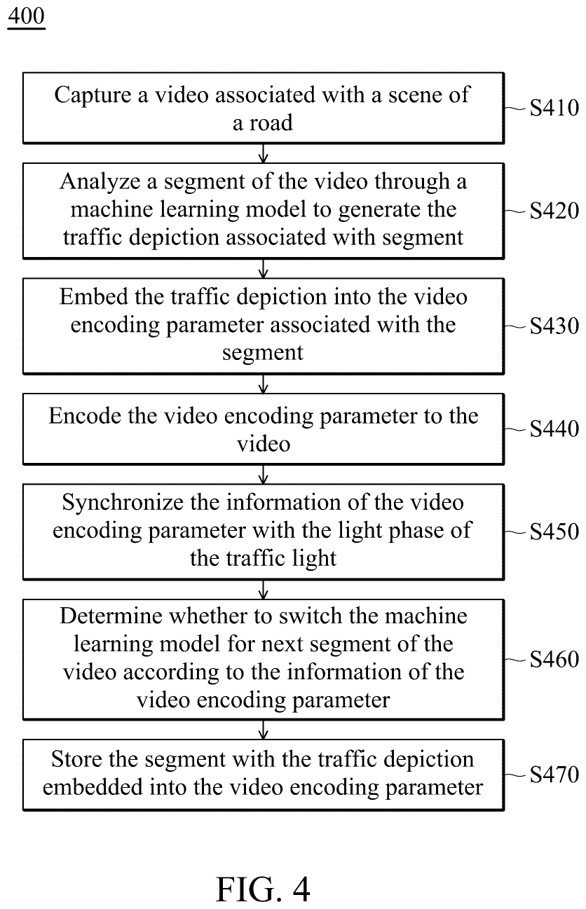

FIG. 4 is a flow chart illustrating a traffic analyzing process 400 according to an embodiment of the invention. The traffic analyzing process can be allied to the traffic analyzing device 110. As shown in FIG. 4, in step S410, the traffic analyzing device 110 may capture a video associated with a scene of a road.

In step S420, the traffic analyzing device 110 may analyze a segment of the video through a machine learning model (e.g., a CNN model and/or a transformer model, but the invention should not be limited thereto) to generate the traffic depiction associated with segment.

In step S430, the traffic analyzing device 110 may embed (or pack) the traffic depiction into the video encoding parameter (e.g., SEI) associated with the segment.

In step S440, the traffic analyzing device 110 may encode the video encoding parameter (e.g., SEI) to the video (e.g., H.264 video or H.264 stream).

In step S450, the traffic analyzing device 110 may synchronize the information of the video encoding parameters (e.g., SEI with the light phase of the traffic light). The synchronization may be intended for aligning contextual information, such as traffic signal states with the video data, rather than for achieving precise time synchronization. By embedding or associating traffic light phase metadata within the video stream, the system may enable downstream devices or models to interpret traffic behavior more accurately in relation to signal changes.

In step S460, the traffic analyzing device 110 may determine whether to switch the machine learning model for next segment of the video according to the information of the video encoding parameter (e.g., SEI).

In step S470, the traffic analyzing device 110 may store the segment with the traffic depiction embedded into the video encoding parameter (e.g., SEI) for the later analysis for the video.

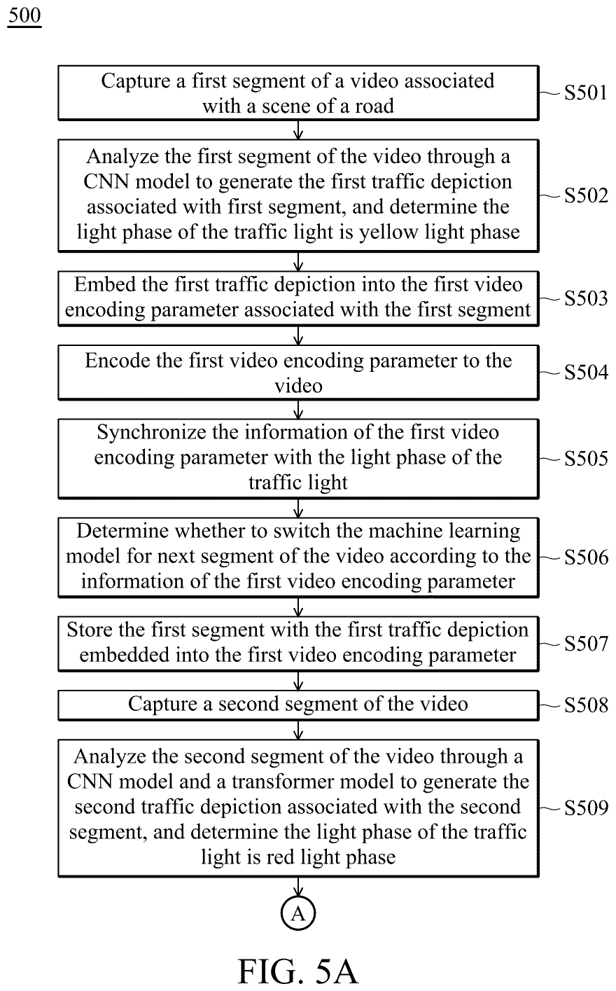

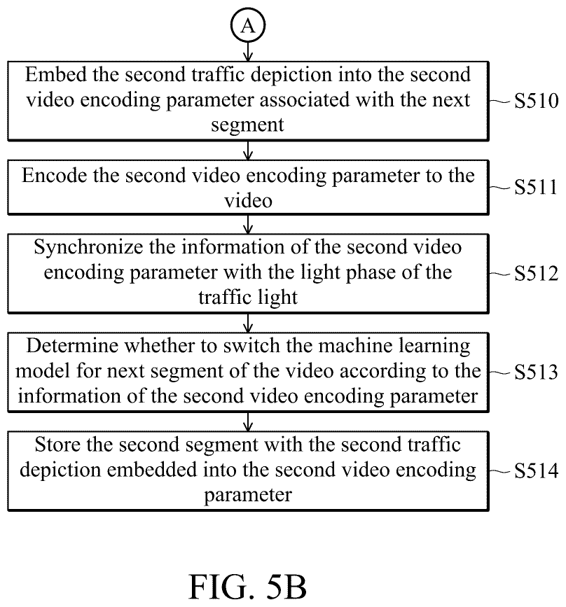

FIG. 5 is a flow chart illustrating a machine learning model switch method 500 based on the light phase of the traffic light according to an embodiment of the invention. The traffic analyzing process can be allied to the traffic analyzing device 110. As shown in FIG. 5, in step S501, the traffic analyzing device 110 may capture a first segment of a video associated with a scene of a road.

In step S502, the traffic analyzing device 110 may analyze the first segment of the video through a CNN model to generate the first traffic depiction associated with first segment, and determine the light phase of the traffic light is yellow light phase according to the first segment or information from a traffic controller. That is, in the embodiment, in an event that the traffic light is yellow light phase, the traffic analyzing device 110 may use the CNN model to perform the object detection and object classification during a shorter period of time (e.g. 1 ms) for generating the first traffic depiction quickly.

In step S503, the traffic analyzing device 110 may embed (or pack) the first traffic depiction into the first video encoding parameter (e.g., SEI) associated with the first segment In step S504, the traffic analyzing device 110 may encode the first video encoding parameter (e.g., SEI) to the video (e.g., H.264 video or H.264 stream).

In step S505, the traffic analyzing device 110 may synchronize the information of the first video encoding parameter (e.g., SEI) with the light phase of the traffic light.

In step S506, the traffic analyzing device 110 may determine whether to switch the machine learning model for next segment (e.g., the second segment) of the video according to the information of the first video encoding parameter (e.g., SEI). For example, according to the information of the first video encoding parameter (e.g., SEI), the traffic analyzing device 110 may determine that in the next segment, the light phase may be switched from the yellow light phase to the red light phase. Therefore, the traffic analyzing device 110 may determine switch to another machine learning model which is suitable for analyzing the next segment, but the invention should not be limited thereto.

In step S507, the traffic analyzing device 110 may store the first segment with the first traffic depiction embedded into the first video encoding parameter (e.g., SEI).

In step S508, the traffic analyzing device 110 may capture a second segment of the video.

In step S509, the traffic analyzing device 110 may analyze the second segment of the video through a CNN model and a transformer model to generate the second traffic depiction associated with the second segment, and determine the light phase of the traffic light is red light phase according to the second segment or information from the traffic controller. Specifically, in the embodiment, in an event that the traffic light is red light phase, the traffic analyzing device 110 may use the CNN model to perform the object detection and object classification during a first period of time (e.g. 1 ms) and use the transformer model to analyze the trajectory of each object from the first segment to the second segment. In an example, because of the time of the yellow light phase is shorter (e.g., 5 second (s)), the traffic analyzing device 110 may fast obtain the wheel trajectory information of each object in the first segment to generate the traffic depiction. Then, in an event that the light phase of the traffic light is red light phase with longer time (e.g., 1 minute), the traffic analyzing device 110 may have enough time to analyze the trajectory of each object from the first segment to the second segment according to the second traffic depiction associated with the second segment and the pre-stored information obtained at the yellow light phase.

In step S510, the traffic analyzing device 110 may embed (or pack) the second traffic depiction into the second video encoding parameter (e.g., SEI) associated with the next segment.

In step S511, the traffic analyzing device 110 may encode the second video encoding parameter (e.g., SEI) to the video (e.g., H.264 video or H.264 stream).

In step S512, the traffic analyzing device 110 may synchronize the information of the second video encoding parameter (e.g., SEI) with the light phase of the traffic light.

In step S513, the traffic analyzing device 110 may determine whether to switch the machine learning model for next segment of the video according to the information of the second video encoding parameter (e.g., SEI).

In step S514, the traffic analyzing device 110 may store the second segment with the second traffic depiction embedded into the second video encoding parameter (e.g., SEI).

According to an embodiment of the invention, the traffic analyzing device 110 may switch the machine learning model currently used to another machine learning model in an event that the server 120 indicates that the accuracy of the machine learning model is lower than the accuracy of another machine learning model. Specifically, the server 120 may obtain the segment of the video with the traffic depiction embedded in the video encoding parameter (e.g., SEI) of the segment, and analyze the traffic depiction to determine whether the accuracy of the machine learning model which being used by the traffic analyzing device 110 is accurate enough (e.g., determine whether the accuracy of the machine learning model is lower than a threshold). In an event that the accuracy of the machine learning model which being used by the traffic analyzing device 110 is not accurate enough, the server 120 may indicate the traffic analyzing device 110 to use another machine learning model with higher accurate (e.g., a machine learning model with the accuracy which is higher than a threshold) to process the segment of the video.

According to an embodiment of the invention, the traffic analyzing device 110 may determine whether to update the first machine learning model and/or second machine learning model according to an indication from the server 120. The server 120 may calculates a computational resource (a computational capability) of the traffic analyzing device 110 to generate the indication.

According to an embodiment of the invention, in an event that the traffic analyzing device 110 comprise more than one camera, the traffic analyzing device 110 may generate a distributed traffic depiction according to the videos from different cameras through a machine learning model (e.g., first machine learning model). Then, the traffic analyzing device 110 may embed the distributed traffic depiction in a video encoding parameter (e.g., SEI) of each video to synchronize the videos. In addition, the traffic analyzing device 110 may determine whether to switch to another machine learning model according to the distributed traffic depiction.

According to an embodiment of the invention, different traffic analyzing devices 110 may be configured in each corner of the intersection. The server (or a backend apparatus) 120 may receive the video with the traffic depiction from each traffic analyzing device 110. Then, the server 120 may analyze the video encoding parameter (e.g., SEI) of each video to synchronize the videos from different traffic analyzing devices 110. In addition, the server 120 may analyze the video encoding parameter (e.g., SEI) of each video to determine whether to update the machine learning model of each traffic analyzing device 110. In another embodiments, each traffic analyzing device 110 may also transmit the video stream or extracted traffic features, along with the generated traffic depiction, to other traffic analyzing devices configured at the intersection. According to an embodiment of the invention, multiple traffic analyzing devices deployed at the same intersection may collaboratively generate a unified traffic depiction. The collaboration may be facilitated through the use of a structured data exchange protocol, such as Protocol Buffers (Protobuf), which enables efficient, low-latency, and platform-independent communication between devices.

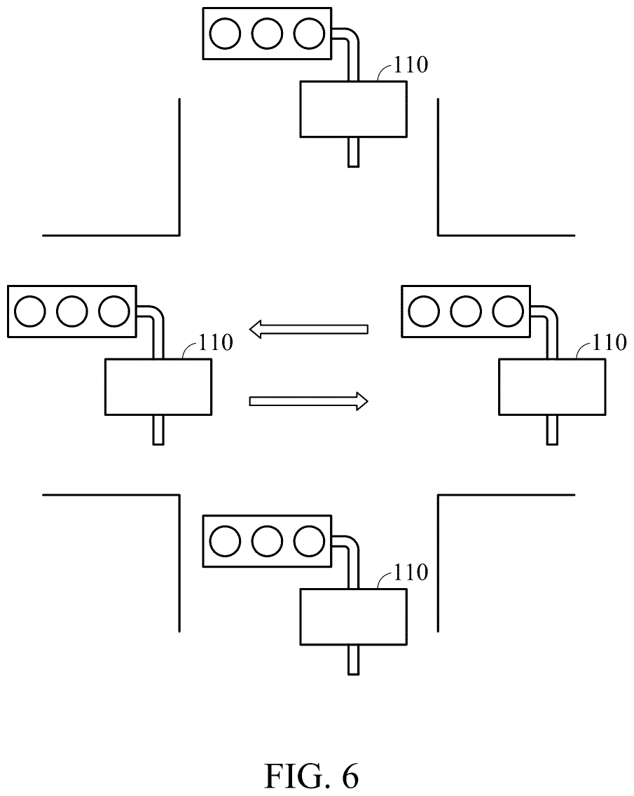

FIG. 6 is a schematic diagram illustrating a traffic analyzing for an intersection according to an embodiment of the invention. As shown in FIG. 6, different traffic analyzing devices 110 may be respectively configured in four corners of the intersection. The server (or a backend apparatus) 120 may receive the video from each traffic analyzing device 110. Then, the server 120 may analyze the video encoding parameter (e.g., SEI) of each video to synchronize the videos from different traffic analyzing devices 110, and to determine whether to update the machine learning model of each traffic analyzing device 110.

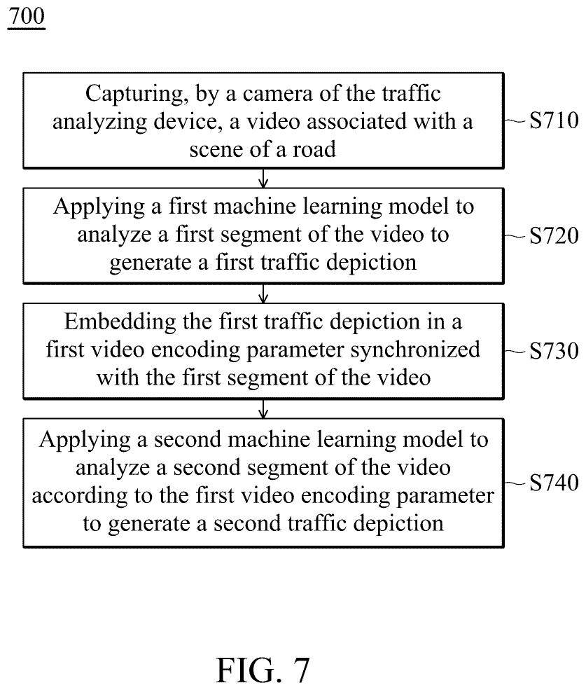

FIG. 7 is a flow chart illustrating a traffic analyzing method 700 according to an embodiment of the invention. The rate adaptation method can be applied to the traffic analyzing device 110. As shown in FIG. 7, in step S710, the traffic analyzing device 110 may capture a video associated with a scene of a road.

In step S720, the traffic analyzing device 110 may apply a first machine learning model to analyze a first segment of the video to generate a first traffic depiction.

In step S730, the traffic analyzing device 110 may embed the first traffic depiction in a first video encoding parameter synchronized with the first segment of the video.

In step S740, the traffic analyzing device 110 may apply a second machine learning model to analyze a second segment of the video according to the first video encoding parameter to generate a second traffic depiction.

According to an embodiment of the invention, in the traffic analyzing method, the first machine learning model may comprise a CNN model and the second machine learning model comprises a transformer model.

According to an embodiment of the invention, in the traffic analyzing method, the traffic analyzing device 110 may generate the first traffic depiction during a first period of time, and generate the second traffic depiction from the first segment to the second segment of the video during a second period of time. The second period of time may be longer than the first period of time.

According to an embodiment of the invention, in the traffic analyzing method, the traffic analyzing device 110 may obtain a first location of an object in the first segment of the video through the first machine learning model, encode the first location into the first traffic depiction, obtain a trajectory of the object from the first segment to the second segment through the second machine learning model, and encode the trajectory into the second traffic depiction.

According to an embodiment of the invention, in the traffic analyzing method, the traffic analyzing device 110 may determine a first classification of the object in the first segment through the first machine learning model, encode the first classification into the first traffic depiction, and generate a description of the object from the first segment to the second segment according to the first classification and the trajectory through the second machine learning model.

According to an embodiment of the invention, in the traffic analyzing method, the traffic analyzing device 110 may determine a computational resource of the processor, determine whether to generate the first classification and the first location of the object based on the computational resource, and prioritize generating the first location in an event that the computational resource is not enough.

According to an embodiment of the invention, in the traffic analyzing method, the second segment may follow the first segment of the video. The traffic analyzing device 110 may be further configured to embed the second traffic depiction in a second video encoding parameter synchronized with the second segment.

According to an embodiment of the invention, in the traffic analyzing method, the traffic analyzing device 110 may obtain a second location and a second classification of an object in the second segment through the first machine learning model, and analyze the second segment, the first video encoding parameter, the second location, and the second classification through the second machine learning to generate a description associated with the object.

According to an embodiment of the invention, in the traffic analyzing method, the video may comprise a traffic light. The traffic analyzing device 110 may be further configured to determine a traffic light phase of the traffic light through the first machine learning model.

According to an embodiment of the invention, in the traffic analyzing method, the traffic analyzing device 110 may obtain a traffic light phase of a traffic light from a traffic controller which is connected to the traffic light.

According to an embodiment of the invention, in the traffic analyzing method, the traffic analyzing device 110 may switch the first machine learning model to another machine learning model in an event that a server indicates that an accuracy of the first machine learning model is lower than an accuracy of the another machine learning model.

According to an embodiment of the invention, in the traffic analyzing method, the traffic analyzing device 110 may determine whether to update the first machine learning model and second machine learning model according to an indication from a server. The server may calculate a computational resource of the traffic analyzing device to generate the indication.

According to an embodiment of the invention, in the traffic analyzing method, the first segment and second segment may respectively comprise a first GOP and a second GOP. The first video encoding parameter and a second video encoding parameter may respectively include a first SEI following the first GOP and a second SEI following the second GOP.

According to an embodiment of the invention, in the traffic analyzing method, in response to a green light phase of a traffic light, the traffic analyzing device 110 may apply a traffic counting model to count the number of vehicles on the road in a segment of the video preceding the first segment of the video. In response to a yellow light phase of the traffic light, the traffic analyzing device 110 may apply a fast wheel trajectory model to generate trajectories of vehicles in a segment of the video. In response to a red light phase of the traffic light, the traffic analyzing device 110 may apply a fleet length calculation model to generate a total length of vehicles traveling on the road in a segment of the video.

According to an embodiment of the invention, in the traffic analyzing method, the traffic analyzing device 110 may generate a distributed traffic depiction according to a plurality of videos from different cameras through the first machine learning model, embed the distributed traffic depiction in a video encoding parameter of each video, and determine whether to switch to another machine learning model according to the distributed traffic depiction.

According to the traffic analyzing method provided in the embodiments of the invention, the analyzing result (i.e., the traffic depiction) of the machine learning model can be embedded or packed in the video encoding parameter (e.g., SEI) of the video. Therefore, the traffic analyzing device and/or the server can determine whether to switch the machine learning model according to the information of the video encoding parameter (e.g., SEI) of the video. In addition, according to the traffic analyzing method provided in the embodiments of the invention, the traffic analyzing device and/or the server can determine the road conditions more immediately.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A traffic analyzing device, comprising:
a camera, configured to capture a video associated with a scene of a road;
a processor; and
a memory coupled to the processor, wherein the processor is configured to:
apply a first machine learning model to analyze a first segment of the video to generate a first traffic depiction;
embed the first traffic depiction in a first video encoding parameter synchronized with the first segment of the video; and
apply a second machine learning model to analyze a second segment of the video according to the first video encoding parameter to generate a second traffic depiction.

2. The traffic analyzing device as claimed in claim 1, wherein the first machine learning model comprises a convolutional neural network (CNN) model and the second machine learning model comprises a transformer model.

3. The traffic analyzing device as claimed in claim 2, wherein the processor is further configured to:
generate the first traffic depiction during a first period of time; and
generate the second traffic depiction from the first segment to the second segment of the video during a second period of time,
wherein the second period of time is longer than the first period of time.

4. The traffic analyzing device as claimed in claim 2, wherein the processor is further configured to:
obtain a first location of an object in the first segment of the video through the first machine learning model;
encode the first location into the first traffic depiction;
obtain a trajectory of the object from the first segment to the second segment through the second machine learning model; and
encode the trajectory into the second traffic depiction.

5. The traffic analyzing device as claimed in claim 4, wherein the processor is further configured to:
determine a first classification of the object in the first segment through the first machine learning model;
encode the first classification into the first traffic depiction; and
generate a description of the object from the first segment to the second segment according to the first classification and the trajectory through the second machine learning model.

6. The traffic analyzing device as claimed in claim 5, wherein the processor is further configured to:
determine a computational resource of the traffic analyzing device;
determine whether to generate the first classification and the first location of the object based on the computational resource; and
prioritize generating the first location in an event that the computational resource is not enough.

7. The traffic analyzing device as claimed in claim 1, wherein the second segment follows the first segment of the video, and the processor is further configured to embed the second traffic depiction in a second video encoding parameter synchronized with the second segment.

8. The traffic analyzing device as claimed in claim 1, wherein the processor is further configured to:
obtain a second location and a second classification of an object in the second segment through the first machine learning model; and
analyze the second segment, the first video encoding parameter, the second location, and the second classification through the second machine learning model to generate a description associated with the object.

9. The traffic analyzing device as claimed in claim 1, wherein the video comprises a traffic light, and the processor is further configured to determine a traffic light phase of the traffic light through the first machine learning model.

10. The traffic analyzing device as claimed in claim 1, wherein the processor is further configured to:
obtain a traffic light phase of a traffic light from a traffic controller which is connected to the traffic light.

11. The traffic analyzing device as claimed in claim 1, wherein the processor is configured to:
switch the first machine learning model to another machine learning model in an event that a server indicates that an accuracy of the first machine learning model is lower than an accuracy of the another machine learning model.

12. The traffic analyzing device as claimed in claim 1, wherein the processor is configured to:
determine whether to update the first machine learning model and second machine learning model according to an indication from a server,
wherein the server calculates a computational resource of the traffic analyzing device to generate the indication.

13. The traffic analyzing device as claimed in claim 1, wherein the first segment and second segment respectively comprise a first group of pictures (GOP) and a second GOP, and wherein the first video encoding parameter and a second video encoding parameter respectively include a first supplemental enhancement information (SEI) following the first GOP and a second SEI following the second GOP.

14. The traffic analyzing system as claimed in claim 1, wherein the processor is further configured to:
in response to a green light phase of a traffic light, apply a traffic counting model to count a number of vehicles on the road in a segment of the video preceding the first segment of the video;
in response to a yellow light phase of the traffic light, apply a fast wheel trajectory model to generate trajectories of vehicles in a segment of the video; or
in response to a red light phase of the traffic light, apply a fleet length calculation model to generate a total length of vehicles traveling on the road in a segment of the video.

15. The traffic analyzing device as claimed in claim 1, wherein the processor is further configured to:
generate a distributed traffic depiction according to a plurality of videos from different cameras through the first machine learning model;
embed the distributed traffic depiction in a video encoding parameter of each video; and
determine whether to switch to another machine learning model according to the distributed traffic depiction.

16. A traffic analyzing method, applied to a traffic analyzing device, comprising:
capturing, by a camera of the traffic analyzing device, a video associated with a scene of a road;
applying, by a processor of the traffic analyzing device, a first machine learning model to analyze a first segment of the video to generate a first traffic depiction;
embedding, by the processor, the first traffic depiction in a first video encoding parameter synchronized with the first segment of the video; and
applying, by the processor, a second machine learning model to analyze a second segment of the video according to the first video encoding parameter to generate a second traffic depiction.

17. The traffic analyzing method as claimed in claim 16, wherein the first machine learning model comprises a convolutional neural network (CNN) model and the second machine learning model comprises a transformer model.

18. The traffic analyzing method as claimed in claim 17, further comprising:
generating, by the processor, the first traffic depiction during a first period of time; and
generating, by the processor, the second traffic depiction from the first segment to the second segment of the video during a second period of time,
wherein the second period of time is longer than the first period of time.

19. The traffic analyzing device as claimed in claim 17, further comprising:
obtaining, by the processor, a first location of an object in the first segment of the video through the first machine learning model;
encoding, by the processor, the first location into the first traffic depiction;
obtaining, by the processor, a trajectory of the object from the first segment to the second segment through the second machine learning model; and
encoding, by the processor, the trajectory into the second traffic depiction.

20. The traffic analyzing method as claimed in claim 19, further comprising:
determining, by the processor, a first classification of the object in the first segment through the first machine learning model;
encoding, by the processor, the first classification into the first traffic depiction; and
generating, by the processor, a description of the object from the first segment to the second segment according to the first classification and the trajectory through the second machine learning model.

21. The traffic analyzing method as claimed in claim 20, further comprising:
determining, by the processor, a computational resource of the traffic analyzing device;
determining, by the processor, whether to generate the first classification and the first location of the object based on the computational resource; and
prioritizing generating, by the processor, the first location in an event that the computational resource is not enough.

22. The traffic analyzing method as claimed in claim 16, wherein the second segment follows the first segment of the video, and the processor is further configured to embed the second traffic depiction in a second video encoding parameter synchronized with the second segment.

23. The traffic analyzing method as claimed in claim 16, further comprising:
obtaining, by the processor, a second location and a second classification of an object in the second segment through the first machine learning model; and
analyzing, by the processor, the second segment, the first video encoding parameter, the second location, and the second classification through the second machine learning model to generate a description associated with the object.

24. The traffic analyzing method as claimed in claim 16, wherein the video comprises a traffic light, and the processor is further configured to determine a traffic light phase of the traffic light through the first machine learning model.

25. The traffic analyzing method as claimed in claim 16, further comprising:
obtaining, by the processor, a traffic light phase of a traffic light from a traffic controller which is connected to the traffic light.

26. The traffic analyzing method as claimed in claim 16, further comprising:
switching, by the processor, the first machine learning model to another machine learning model in an event that a server indicates that an accuracy of the first machine learning model is lower than an accuracy of the another machine learning model.

27. The traffic analyzing method as claimed in claim 16, further comprising:
determining, by the processor, whether to update the first machine learning model and second machine learning model according to an indication from a server,
wherein the server calculates a computational resource of the traffic analyzing device to generate the indication.

28. The traffic analyzing method as claimed in claim 16, wherein the first segment and second segment respectively comprise a first group of pictures (GOP) and a second GOP, and wherein the first video encoding parameter and a second video encoding parameter respectively include a first supplemental enhancement information (SEI) following the first GOP and a second SEI following the second GOP.

29. The traffic analyzing method as claimed in claim 16, further comprising:
in response to a green light phase of a traffic light, applying, by the processor, a traffic counting model to count a number of vehicles on the road in a segment of the video preceding the first segment of the video;
in response to a yellow light phase of the traffic light, applying, by the processor, a fast wheel trajectory model to generate trajectories of vehicles in a segment of the video; or
in response to a red light phase of the traffic light, applying, by the processor, a fleet length calculation model to generate a total length of vehicles traveling on the road in a segment of the video.

30. The traffic analyzing method as claimed in claim 16, further comprising:
generating, by the processor, a distributed traffic depiction according to a plurality of videos from different cameras through the first machine learning model;
embedding, by the processor, the distributed traffic depiction in a video encoding parameter of each video; and
determining, by the processor, whether to switch to another machine learning model according to the distributed traffic depiction.
